(19) United States
(12) Patent Application Publication
(10) Pub. No.: US 2013/0147851 A1
(43) Pub. Date: Jun. 13, 2013

(54) DISPLAY APPARATUS FOR CONTROLLING OPTICAL TRANSMITTANCE

(71) Applicants: Sang-Hoon Yim, Yongin-city (KR); Jun-Ho Choi, Yongin-city (KR); Seong-Min Kim, Yongin-city (KR)

(72) Inventors: Sang-Hoon Yim, Yongin-city (KR); Jun-Ho Choi, Yongin-city (KR); Seong-Min Kim, Yongin-city (KR)

(21) Appl. No.: 13/398,795

(22) Filed: Feb. 16, 2012

(30) Foreign Application Priority Data
Dec. 8, 2011 (KR) 10-2011-0131120

(51) Int. Cl. G09G 5/02; G09G 5/10

(52) U.S. Cl. 345/690

(57) ABSTRACT

A display apparatus for controlling optical transmittance thereof, is provided. The display apparatus includes: a display panel including a pixel having a first region for emitting light via at least one surface thereof and a second region disposed adjacent to the first region and for transmitting external light therethrough; a signal generator for generating a signal including image words representing image data corresponding to the light emitted from the first region, wherein one or more transmittance bits of the signal represent transmittance of the second region; and a transmittance control device for controlling transmittance of the second region based on the one or more transmittance bits.

### CROSS-REFERENCE TO RELATED PATENT APPLICATION

This application claims priority to and the benefit of Korean Patent Application No. 10-2011-0131120, filed on Dec. 8, 2011, in the Korean Intellectual Property Office, the disclosure of which is incorporated herein in its entirety by reference.

### BACKGROUND

1. Field

The present invention relates to a display apparatus.

2. Description of Related Art

Organic light-emitting display apparatuses have larger viewing angles, better contrast characteristics, and faster response times, and consume less power than other display apparatuses, and thus have been used in various fields of application, e.g., personal mobile devices, such as MP3 players and mobile phones, and TVs. An organic light-emitting display apparatus has self-light emitting characteristics, and its weight and thickness may be reduced because it does not require an additional light source, unlike a liquid crystal display (LCD) apparatus. Also, an organic light-emitting display apparatus may be manufactured to be a transparent display apparatus by including transparent thin-film transistors (TFTs) and/or transparent organic light-emitting diodes (OLEDs) therein, and by forming a transmissive region (or a transmissive window) separate from a pixel region.

However, the transmittance of such a transparent display apparatus is generally fixed, and thus, a user cannot adjust the transmittance to a desired level.

### SUMMARY

Exemplary embodiments according to the present invention provide a display apparatus for controlling an optical transmittance of a display panel according to a mode. A display apparatus may reduce deterioration of a constant ratio according to a mode by controlling transmittance of a transparent display device pixel by pixel (e.g., by providing for a pixel level transmittance control). A method of driving the display apparatus is also provided.

According to an aspect of embodiments according to the present invention, there is provided a display apparatus for controlling optical transmittance thereof, the display apparatus including: a display panel including a pixel having a first region for emitting light via at least one surface thereof and a second region disposed adjacent to the first region and for transmitting external light therethrough; a signal generator for generating a signal including image words representing image data corresponding to the light emitted from the first region, one or more transmittance bits of the signal representing transmittance of the second region; and a transmittance control device for controlling transmittance of the second region based on the one or more transmittance bits.

The first region of the pixel may include a light emission unit for each of a red sub pixel, a green sub pixel, and a blue sub pixel of the pixel, and the second region may be independently disposed for each of the red sub pixel, the green sub pixel, and the blue sub pixel, or may be coupled thereto.

The image data may include a red signal, a green signal, and a blue signal, wherein the image words may include a red word representing the red signal, a green word representing the green signal, and a blue word representing the blue signal.

At least one bit of the red word may be allocated to the one or more transmittance bits.

At least one bit of the blue word may be allocated to the one or more transmittance bits.

At least one bit is added to the image words as the one or more transmittance bits.

The transmittance control device may include: an optical reflectance conversion device disposed at another side opposite to a side of the display panel via which light is emitted from the display panel, and may change reflectance of the external light according to the one or more transmittance bits.

The transmittance control device may include: a retarder disposed at another side opposite to the side of the display panel via which light is emitted from the display panel, may delay a phase of the external light according to the one or more transmittance bits, and may transmit the external light.

The display apparatus may further include: a storage unit for storing the image words as image information, wherein the storage unit is configured to store the one or more transmittance bits.

According to an aspect of embodiments according to the present invention, there is provided a display apparatus for controlling optical transmittance thereof, the display apparatus including: a display panel for selectively operating in a first mode in a transparent state in which external light transmits through the display panel for displaying an image and in a second mode in an opaque state in which the external light is blocked from at least a part of the display panel; a signal generator for generating a signal including image words representing image data, one or more transmittance bits of the signal representing transmittance information used to control block or transmission of the external light; and a transmittance control device for controlling transmittance of the external light based on the one or more transmittance bits.

The display panel may include pixels each including a first region including a light emission unit for each of a red sub pixel, a green sub pixel, and a blue sub pixel, and configured to emit light, and a second region adjacent to the first region, configured to transmit external light therethrough, and independently disposed for each of the red sub pixel, the green sub pixel, and the blue sub pixel or coupled thereto.

The image words may include a red word representing the red signal, a green word representing the green signal, and a blue word representing the blue signal.

At least one bit of the red word may be allocated to the one or more transmittance bits, and the one or more transmittance bits may include an LSB of the red word.

At least one bit of the blue word may be allocated to the one or more transmittance bits, and the one or more transmittance bits may include an LSB of the blue word.

At least one bit may be added to the image words as the one or more transmittance bits.

The transmittance control device may include: an optical reflectance conversion device disposed at another side opposite to a side of the display panel via which light is emitted from the display panel, and may change reflectance of the external light according to the one or more transmittance bits.

The transmittance control device may include: a retarder disposed at another side opposite to the side of the display panel via which light is emitted from the display panel, may delay a phase of the external light according to the one or more transmittance bits, and may transmit the external light.

The display apparatus may further include: a storage unit for storing the image words as image information, wherein the storage unit may be configured to store the one or more transmittance bits.

### BRIEF DESCRIPTION OF THE DRAWINGS

The above and other features and aspects of the present invention will become more apparent by describing in detail exemplary embodiments thereof with reference to the attached drawings in which:

FIG. 1 is a schematic cross-sectional view of a display panel according to an embodiment of the present invention;

FIG. 2 illustrates a pixel included in a transparent display device of FIG. 1, according to an embodiment of the present invention;

FIG. 3 illustrates a pixel included in the transparent display device of FIG. 1, according to another embodiment of the present invention;

FIG. 4 is a cross-sectional view of one of a plurality of sub pixels of the pixel of FIGS. 2 and 3;

FIG. 5 is a schematic cross-sectional view of a display panel according to another embodiment of the present invention;

FIG. 6 illustrates a pixel included in a transparent display device of FIG. 5, according to another embodiment of the present invention;

FIG. 7 illustrates a pixel included in the transparent display device of FIG. 5, according to another embodiment of the present invention;

FIG. 8 is a cross-sectional view of one of a plurality of sub pixels of the pixel of FIGS. 6 and 7;

FIG. 9 illustrates an example of an image displayed in a transparent mode according to an embodiment of the present invention;

FIG. 10 illustrates an example of an image displayed in a black mode according to an embodiment of the present invention;

FIG. 11 illustrates an example of an image displayed in a partial black mode according to an embodiment of the present invention;

FIG. 12 is a schematic block diagram of a display apparatus according to an embodiment of the present invention;

FIGS. 13A through 15 are diagrams for explaining a structure of transparent data according to an embodiment of the present invention; and

FIGS. 16 and 17 are schematic cross-sectional views of display panels capable of controlling optical transmittance according to embodiments of the present invention.

### DETAILED DESCRIPTION

As the present invention allows for various changes and numerous embodiments, exemplary embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, some of the detailed explanations of related art may have been omitted when it is deemed that they may unnecessarily obscure the essence of the invention.

While such terms as “first,” “second,” etc., may be used to describe various components, such components must not be limited to the above terms. The above terms are used only to distinguish one component from another for the purposes of providing a clear description.

The terms used in the present specification are merely used to describe exemplary embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Expressions such as “at least one of,” when preceding a list of elements, modify the entire list of elements and do not modify the individual elements of the list.

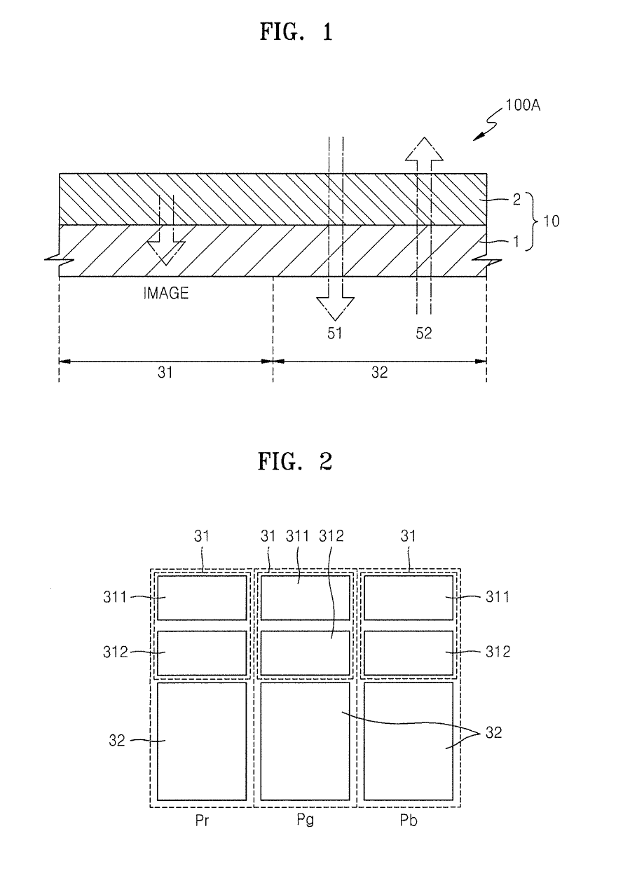

FIG. 1 is a schematic cross-sectional view of a display panel 100A according to an embodiment of the present invention. Referring to FIG. 1, the display panel 100A includes a transparent display device 10 that transmits external light therethrough. The transparent display device 10 may be a light-emitting display panel that is a bottom emission type display device, and may include a first substrate 1, a display unit disposed on the first substrate 1, and a second substrate 2 that seals the display unit. The display unit is divided into a plurality of pixels each including a pixel region 31 for emitting light and displaying an image toward the first substrate 1, and a transmissive region 32 that is disposed adjacent to the pixel region 31 and that transmits external light therethrough.

According to an embodiment of the present invention, if the display panel 100A operates in the transparent mode, the display panel 100A is in a transparent state. A user who is at a side where an image is displayed may view an object located at or an image displayed at an opposite side (e.g., an outer side of the second substrate 2) by using first external light 51 transmitted in a direction from the outer side of the second substrate 2 to an outer side of the first substrate 1. Also, a user who is at a side opposite to the side where an image is displayed may also view an object located at or an image displayed at the outer side of the first substrate 1 by using second external light 52 transmitted in a direction from the outer side of the first substrate 1 to the outer side of the second substrate 2. The first external light 51 is transmitted in a direction in which the image is displayed, and the second external light 52 is transmitted in a direction opposite to the direction of the first external light 51.

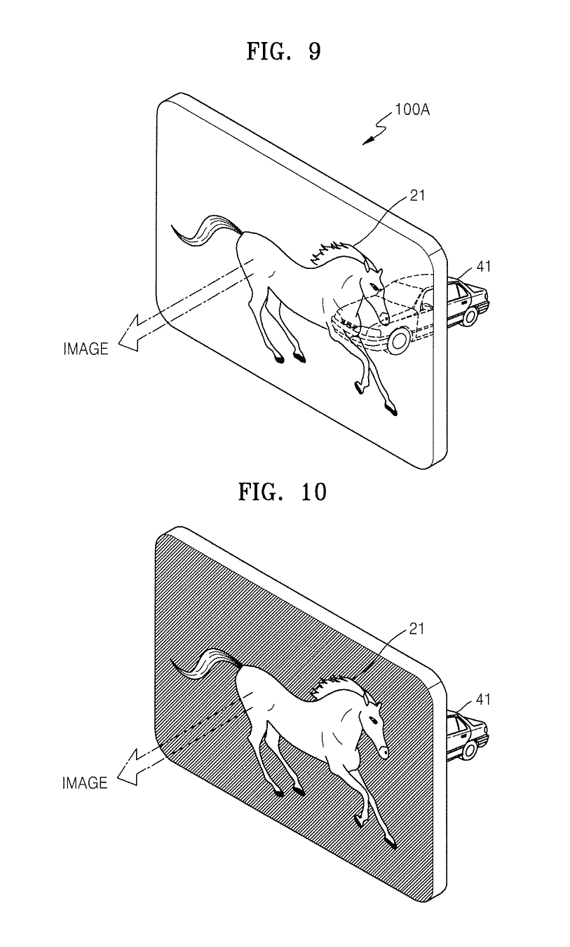

FIG. 9 illustrates an example of an image displayed in a transparent mode according to an embodiment of the present invention. Referring to FIG. 9, the display panel 100A may enable a user who is at a side where an image 21 is displayed to view an object or an image 41 located at a side opposite to the side where the image 21 is displayed through external light transmitted in a direction to the side where the image 21 is displayed, from the side opposite to the side where the image 21 is displayed.

Further, if the display panel 100A operates in a black mode for blocking light, the display panel 100A is in an opaque state. A user who is at the side where an image is displayed cannot view an object located at or an image displayed at an opposite side (e.g., the outer side of the second substrate 2). A user who is at the side opposite to the side where the image is displayed also cannot view an image displayed at the outer side of the first substrate 1.

FIG. 10 illustrates an example of an image displayed in a black mode according to an embodiment of the present invention. Referring to FIG. 10, a user who is at a side where the image 21 is displayed cannot view an object or the image 41 located at a side opposite to the side where the image 21 is displayed.

Further, according to an embodiment of the present invention, the black mode can be a partial black mode in which an opaque region through which light is not transmitted is set on the display panel 100A. In this case, the display panel 100A is divided into a transparent region and an opaque region. A user who is at a side where an image is displayed cannot view an object located at or an image displayed at an opposite side (e.g., the outer side of the second substrate 2) in the opaque region. A user who is in the side opposite to the side where the image is displayed cannot also view an image displayed at the outer side of the first substrate 1 in the opaque region.

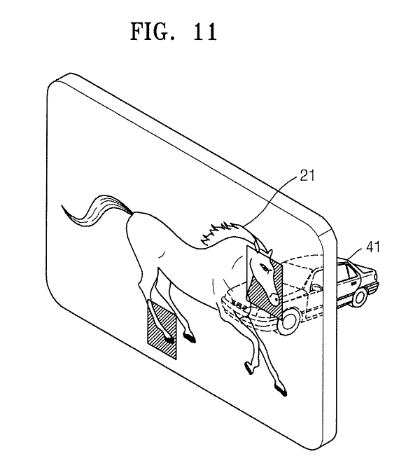

FIG. 11 illustrates an example of an image displayed in a partial black mode according to an embodiment of the present invention. Referring to FIG. 11, a user who is at a side where the image 21 is displayed cannot view an object or the image 41 located at a side opposite to the side where the image 21 is displayed, in an opaque region. Meanwhile, the user who is at the side where the image 21 is displayed can view the object or the image 41 located at the side opposite to the side where the image 21 is displayed, in a transparent region other than the opaque region.

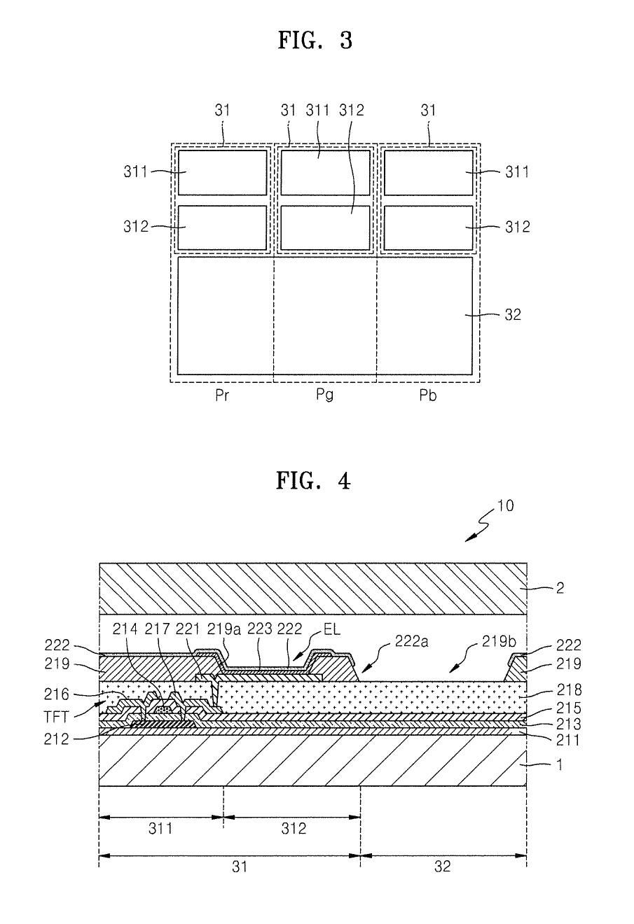

FIG. 2 illustrates a pixel included in the transparent display device 10 of FIG. 1, according to an embodiment of the present invention. FIG. 3 illustrates a pixel included in the transparent display device 10 of FIG. 1, according to another embodiment of the present invention.

Referring to FIGS. 2 and 3, the pixel may include a plurality of sub pixels, e.g., a red sub pixel Pr, a green sub pixel Pg, and a blue sub pixel Pb.

Each of the red, green, and blue sub pixels Pr, Pg, and Pb includes a pixel region 31 and a transmissive region 32. In the pixel region 31, a pixel circuit unit 311 and a light-emitting unit 312 are disposed adjacent to each other not to overlap with each other, so that an optical path may not be blocked by the pixel circuit unit 311 when bottom emission occurs in the light-emitting unit 312 toward the first substrate 1.

The transmissive region 32 that transmits external light therethrough is disposed adjacent to the pixel region 31.

The transmissive regions 32 may be disposed to respectively correspond to the red, green, and blue sub pixels Pr, Pg, and Pb to be apart from each other as illustrated in FIG. 2 or to be coupled (e.g., connected) to each other as illustrated in FIG. 3. In other words, in the entire region of the display unit, the pixel may include a plurality of pixel regions 31 that are disposed apart from each other between common transmissive regions 32. The area of the transmissive regions 32 that transmit external light therethrough in the embodiment of FIG. 3, is larger than in the embodiment of FIG. 2, thereby increasing the overall transmittance of the display unit.

Although FIG. 3 illustrates that all the transmissive regions 32 corresponding to the red sub pixel Pr, the green sub pixel Pg, and the blue sub pixel Pb are coupled (e.g., connected) to each other, the present invention is not limited thereto and the transmissive regions 32 corresponding to two adjacent sub pixels from among the red sub pixel Pr, the green sub pixel Pg, and the blue sub pixel Pb may be coupled (e.g., connected) to each other.

FIG. 4 is a cross-sectional view of one of the red, green, and blue sub pixels Pr, Pg, and Pb illustrated in FIGS. 2 and 3. As illustrated in FIG. 4, in a pixel circuit unit 311 of the pixel region 31, one thin-film transistor (TFT) is disposed, but the present invention is not limited thereto and a pixel circuit including the TFT may be disposed. The pixel circuit unit 311 may further include a plurality of TFTs and a storage capacitor. Also, the pixel circuit unit 311 may further include a scan line, a data line, and a Vdd line connected to the plurality of TFTs and the storage capacitor.

In the light-emitting unit 312 of the pixel region 31, an organic emission device EL that is a light-emitting device is disposed. The organic emission device EL is electrically connected to the TFT of the pixel circuit unit 311.

First, a buffer layer 211 is formed on a first substrate 1, and the pixel circuit including the TFT is formed on the buffer layer 211.

A semiconductor active layer 212 is formed on the buffer layer 211.

The buffer layer 211 protects the substrate 1 from impurities and planarizes a surface of the substrate 1. The buffer layer 211 may be formed of any of various materials that can perform the functions described above. For example, the buffer layer 21 may be formed of an inorganic material, such as a silicon oxide, a silicon nitride, a silicon oxynitride, an aluminum oxide, an aluminum nitride, a titanium oxide, or a titanium nitride; an organic material, such as polyimide, polyester, or acryl; or a stacked structure of these inorganic and/or organic materials. In some embodiments, the buffer layer 211 may not be an essential element and thus may not be formed.

The semiconductor active layer 212 may be formed of polycrystal silicon, but is not limited thereto and may be formed of a semiconductor oxide. For example, the semiconductor active layer 212 may be a G-I-Z-O layer [(In₂O₃)ₐ(Ga₂O₃)_{b}(ZnO)_{c} layer], where a, b, and c are integers that respectively satisfy a≧0, b≧0, and c>0. When the semiconductor active layer 212 is formed of a semiconductor oxide, the transmittance of the pixel circuit unit 311 of the pixel region 31 may be improved, thereby increasing the overall transmittance of the display unit.

A gate insulating layer 213 is formed on the buffer layer 211 to cover the semiconductor active layer 212, and a gate electrode 214 is formed on the gate insulating layer 213.

An interlayer insulating layer 215 is formed on the gate insulating layer 213 to cover the gate electrode 214. A source electrode 216 and a drain electrode 217 are formed on the interlayer insulating layer 215, and contact the semiconductor active layer 212 through contact holes, respectively.

The structure of the TFT is not limited to the above description and any type of TFT may be employed.

A passivation layer 218 is formed to cover the TFT. The passivation layer 218 may be a single insulating layer or a plurality of insulating layers, an upper surface of which is planarized. The passivation layer 218 may be formed of an inorganic material and/or an organic material. The passivation layer 218 may be formed to cover both the pixel region 31 and the transmissive region 32 as illustrated in FIG. 4, but is not limited thereto. Although not shown, an aperture (not shown) may be formed at a portion of the passivation layer 218, which corresponds to the transmissive region 32, so that the transmittance efficiency (e.g., transmission efficiency) of external light in the transmissive region 32 may be increased or improved.

Referring to FIG. 4, a first electrode 221 of the organic emission device EL to be electrically connected to the TFT is formed on the passivation layer 218 to be electrically connected to the TFT. A plurality of the first electrodes 221 are disposed in an island pattern independently in units of sub pixels. The first electrode 221 is disposed in the light-emitting unit 312 of the pixel region 31 not to overlap with the pixel circuit unit 311.

A pixel-defining layer 219 formed of an organic material and/or an inorganic material, is formed on the passivation layer 218.

The pixel-defining layer 219 has a third aperture 219a therein in such a manner that edges of the first electrode 221 are covered by the pixel-defining layer 219 and a central part of the first electrode 221 is exposed. The pixel-defining layer 219 may cover the pixel region 31, but is not limited thereto and may cover at least a portion of the pixel region 31, and particularly, may cover the edges of the first electrode 221. A second aperture 219b may be formed at a portion of the pixel-defining layer 219 corresponding to the transmissive region 32, as illustrated in FIG. 4. If the pixel-defining layer 219 is not disposed in the transmissive region 32, the transmittance efficiency of external light in the transmissive region 32 may be increased or improved.

Both the passivation layer 218 and the pixel-defining layer 219 may be formed of a transparent material. In this case, because insulating layers, such as the passivation layer 218 and the pixel-defining layer 219, are formed of a transparent material, the transmittance efficiency of external light of the transparent display device 10 may be increased or improved.

An organic layer 223 and a second electrode 222 are sequentially disposed on the first electrode 221 exposed via the third aperture 219a. The second electrode 222 is disposed in pixel region 31 to face the first electrode 221 and cover the organic layer 223 and the pixel-defining layer 219. The second electrode 222 may be formed at least in the pixel region 31, and may have a first aperture 222a at a portion thereof corresponding to the transmissive region 32, as illustrated in FIG. 4. If the second electrode 222 is not disposed in the transmissive region 32, the transmittance efficiency of external light in the transmissive region 32 may be increased or improved. The first aperture 222a and the second aperture 219b may be coupled (e.g., connected) to each other.

The organic layer 223 may be a low molecular weight organic layer or a polymer organic layer. If the organic layer 223 is a low molecular weight organic layer, the organic layer 223 may be formed by stacking a hole injection layer (HIL), a hole transport layer (HTL), an emission layer (EML), an electron transport layer (ETL), and an electron injection layer (EIL) in a single structure or a composite structure. In this case, the organic layer 223 may be formed of any of various organic materials, such as copper phthalocyanine (CuPc), N,N′-Di(naphthalene-1-yl)-N,N′-diphenyl-benzidine (NPB), or tris-8-hydroxyquinoline aluminum (Alq3). The low-molecular weight organic layer may be formed by vacuum deposition. In this case, the HIL, the HTL, the ETL, and the EIL may be common layers to red, green, and blue pixels.

The first electrode 221 may function as an anode and the second electrode 222 may function as a cathode, or vice versa.

According to an embodiment of the present invention, the first electrode 221 may be a transparent electrode and the second electrode 222 may be a reflective electrode. The first electrode 221 may be formed of a transparent conductive material, such as ITO, IZO, ZnO, In₂O₃, or the like. The second electrode 222 may be formed of Ag, Mg, Al, Pt, Pd, Au, Ni, Nd, Ir, Cr, Li, Ca, or the like. Thus, the organic emission device EL may be a bottom emission type device, in which an image is displayed toward the first electrode 221. In this case, the second electrode 222 may be formed to an appropriate thickness sufficient not to cause a voltage drop to occur in the entire display unit. Accordingly, it is possible to manufacture a large-size (e.g., large area) display panel 100A.

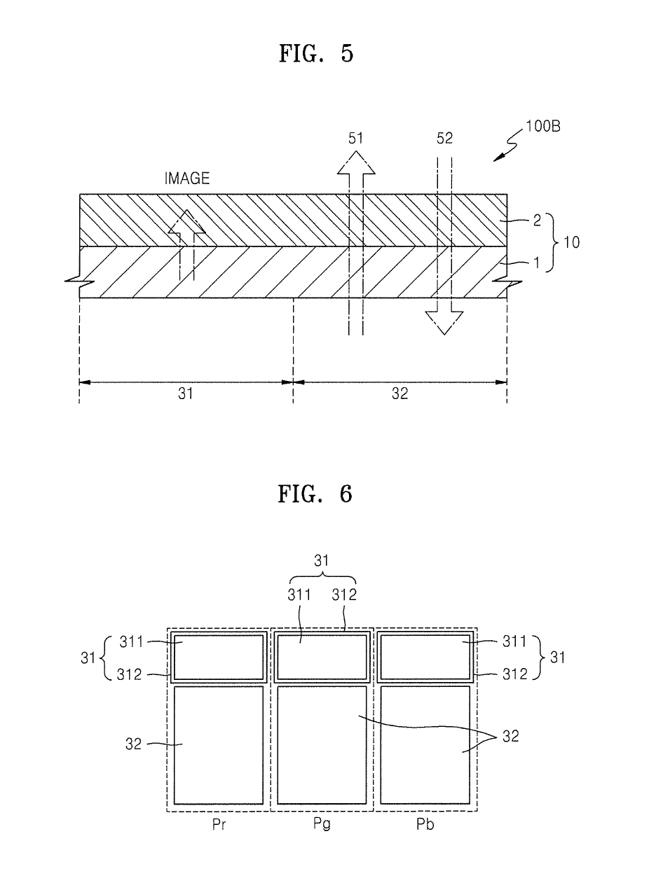

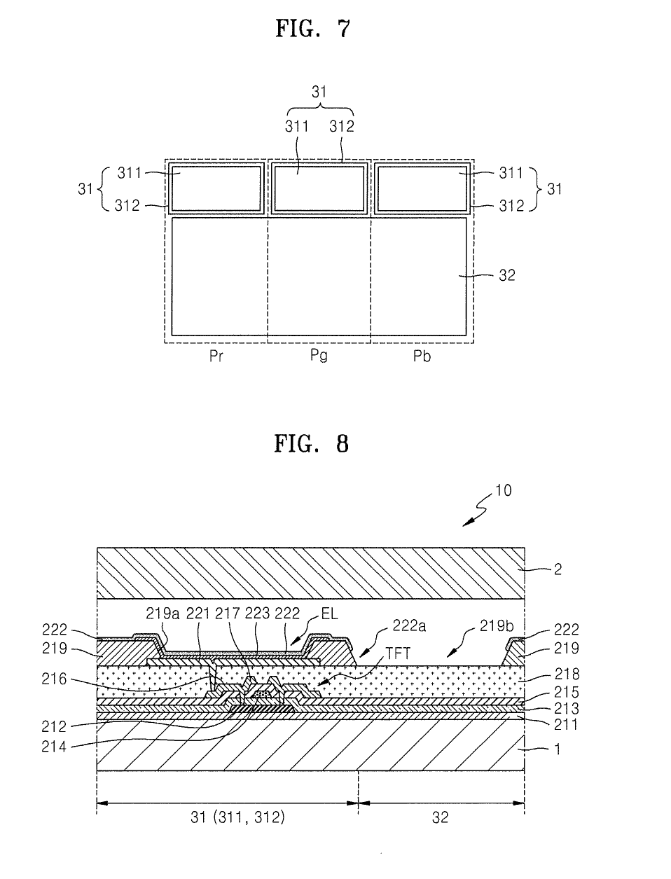

FIG. 5 is a schematic cross-sectional view of a display panel 100B according to another embodiment of the present invention. The display panel 1008 illustrated in FIG. 5 may be a light-emitting display panel in which a transparent display device 10 is a top emission type display device, unlike in the display panel 100A of FIG. 1. The elements of the display panel 100B are substantially the same as those of the display panel 100A of FIG. 1 in terms of their functions and thus will not be described again in detail here. FIG. 6 illustrates a pixel included in the transparent display device 10 of FIG. 5, according to another embodiment of the present invention. FIG. 7 illustrates a pixel included in the transparent display device 10 of FIG. 5, according to another embodiment of the present invention.

Referring to FIGS. 6 and 7, in the pixel, a pixel circuit unit 311 and a light-emitting unit 312 included in a pixel region 31 are disposed to overlap with each other, unlike in the pixel illustrated in FIGS. 2 and 3. Because a top emission occurs in the light-emitting unit 312 toward the second substrate 2, the pixel circuit unit 311 and the light-emitting unit 312 may overlap with each other. In addition, because the pixel circuit unit 311 including a pixel circuit (not shown), is covered by the light-emitting unit 312, it is possible to reduce or prevent optical interference, caused by the pixel circuit. The other elements of the display panel 1008 are substantially the same as those of the display panel 100A of FIG. 2 or 3 in terms of their functions and thus will not be described again in detail here.

The transmissive regions 32 may be disposed to respectively correspond to a plurality of sub pixels Pr, Pg, and Pb to be apart from each other as illustrated in FIG. 6 or are coupled (e.g., connected) to each other as illustrated in FIG. 7.

FIG. 8 is a cross-sectional view of one of the red, green, and blue sub pixels Pr, Pg, and Pb illustrated in FIGS. 6 and 7.

Referring to FIG. 8, a TFT is disposed in the pixel circuit unit 311, and an organic emission device EL, which is a light-emitting device, is disposed in the light-emitting unit 312.

A buffer layer 211 is formed on a first substrate 1, a semiconductor active layer 212 is formed on the buffer layer 211, and a gate insulating layer 213, a gate electrode 214, and an interlayer insulating layer 215 are formed on the semiconductor active layer 212. A source electrode 216 and a drain electrode 217 are formed on the interlayer insulating layer 215. A passivation layer 218, which is a type of insulating layer, is formed to cover the TFT. The passivation layer 218 may cover both the pixel region 31 and the transmissive region 32 as illustrated in FIG. 8, but is not limited thereto. The passivation layer 218 may have an aperture (not shown) at a portion thereof corresponding to the transmissive region 32, thereby increasing or improving the transmittance efficiency of external light in the transmissive region 32.

Referring to FIG. 8, a first electrode 221 of the organic emission device EL being electrically connected to the TFT is disposed on the passivation layer 218.

The first electrode 221 is disposed in the light-emitting unit 312 included in the pixel region 31, and overlaps with the pixel circuit unit 311 so as to cover the pixel circuit unit 311.

A pixel-defining layer 219 formed of an organic material and/or an inorganic material, is disposed on the passivation layer 218.

The pixel-defining layer 219 has a third aperture 219a therein in such a manner that edges of the first electrode 221 are covered by the pixel-defining layer 219 and a central part of the first electrode 221 is exposed. The pixel-defining layer 219 may cover the pixel region 31, but is not limited thereto and may cover at least a portion of the pixel region 31, and particularly, the edges of the first electrode 221. A second aperture 219b may be formed at a portion of the pixel-defining layer 219 corresponding to the transmissive region 32, as illustrated in FIG. 8. When the pixel-defining layer 219 is not disposed in the transmissive region 32, the transmittance efficiency of external light in the transmissive region 32, may be increased or improved.

Both the passivation layer 218 and the pixel-defining layer 219 may be formed of a transparent material. In this case, because insulating layers, such as the passivation layer 218 and the pixel-defining layer 219, are formed of a transparent material, the transmittance efficiency of external light of the transparent display device 10, may be increased or improved.

An organic layer 223 and a second electrode 222 are sequentially disposed on the first electrode 221 exposed via the third aperture 219a. The second electrode 222 may be formed at least in the pixel region 31, and may have a first aperture 222a at a portion thereof corresponding to the transmissive region 32, as illustrated in FIG. 8. When the second electrode 222 is not disposed in the transmissive region 32, the transmittance efficiency of external light in the transmissive region 32, may be increased or improved. The first aperture 222a and the second aperture 219b may be coupled (e.g., connected) to each other.

In the embodiment of FIG. 8, the first electrode 221 may have a stacked structure of a transparent conductor and a reflective layer, and the second electrode 222 may be a semi-transparent and semi-reflective electrode. The transparent conductor may be formed of an oxide having a relatively high work function, such as ITO, IZO, ZnO, or In₂O₃. The reflective layer may be formed of at least one selected from the group consisting of Ag, Mg, Al, Pt, Pd, Au, Ni, Nd, Ir, Cr, Li, Ca, Mo, and an alloy thereof. The first electrode 221 is disposed in the pixel region 31.

The second electrode 222 may be formed of at least one selected from the group consisting of Ag, Mg, Al, Pt, Pd, Au, Ni, Nd, Ir, Cr, Li, Ca, Mo, and an alloy thereof. The second electrode 222 may be formed of a thin film having a thickness between about 100 Å to about 300 Å so that the transmittance thereof may be increased or improved. Accordingly, the organic emission device EL is a top emission type device, in which an image is displayed toward the second electrode 222.

A driving mode of the display panel 100B of FIG. 5 is substantially the same as the driving mode of the display panel 100A of FIG. 1, and may be implemented as examples illustrated in FIGS. 9 through 11.

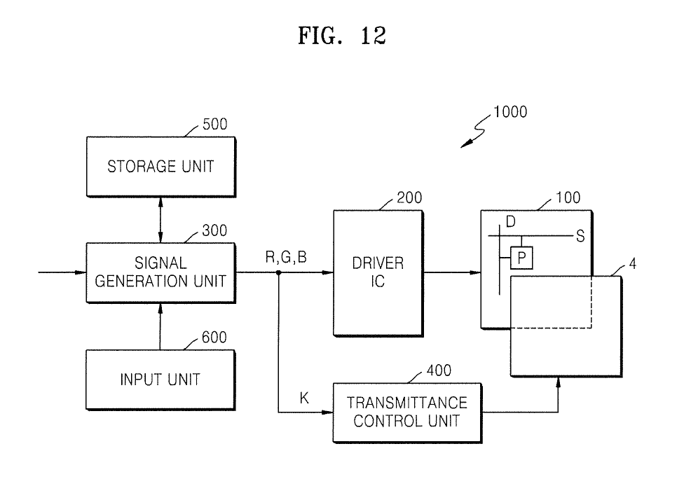

FIG. 12 is a schematic block diagram of a display apparatus 1000 according to an embodiment of the present invention.

The display apparatus 1000 is an electronic apparatus for processing and displaying an image such as a tablet computer, a media storage device, a cellular phone, a personal digital assistant (PDA), or the like.

Referring to FIG. 12, the display apparatus 1000 may include a display panel 100, a driver IC 200, a signal generation unit (e.g., a signal generator) 300, a transmittance control unit (e.g., a transmittance controller) 400, a storage unit 500, and an input unit 600.

The display panel 100 may be implemented, for example, as the display panel 100A or the display panel 100B, including the transparent display device 10 that transmits external light therethrough as illustrated respectively in FIGS. 1 and 5. The display panel 100 includes a plurality of scan lines S, a plurality of data lines D, and a plurality of pixels P. The plurality of scan lines are uniformly spaced apart from each other, arranged in rows, and transfer scan signals. The plurality of data lines D are uniformly spaced apart from each other, arranged in columns, and transfer data signals. The plurality of scan lines S and the plurality of data lines D are arranged in a matrix format. One sub pixel P is formed at a point where the plurality of scan lines S and the plurality of data lines D cross each other. The sub pixel P is shown in FIG. 12 as an example.

In one embodiment of the present invention, a plurality of sub pixels, for example, of the three red, green, and blue sub pixels Pr, Pg, and Pb, may together be grouped and referred to as one pixel. The red, green, and blue sub pixels Pr, Pg, and Pb may be alternately arranged in a row direction or in a column direction. A transmissive region is formed in the pixel per three sub pixels. The transmissive region may be electrical and optical to enable adjustment of transmittance.

The display panel 100 is driven in two modes (a transmissive mode and a black mode (e.g., an opaque mode)) that are determined according to an amount of light transmitted through the transmissive region 32 of the transparent display device 10.

The driver IC 200 may include a scan driver that applies scan signals through the plurality of scan lines S, and a data driver that applies data signals through the plurality of data lines D.

The signal generation unit 300 receives image data DATA and a control signal for controlling a display of the image data DATA from an external graphic controller (not shown). The image data DATA includes a red signal (R signal), a green signal (G signal), and a blue signal (B signal). The RGB signals may be represented by data words including data bits (e.g., predetermined bits). That is, image words constituting the image data DATA may include a red word including red bits that represent the R signal, a green word including green bits that represent the G signal, and a blue word including blue bits that represent the B signal. For example, 8 bits may be allocated to each of the RGB signals per pixel, and thus the RGB signals may be represented by 24 bits as a whole. The control signal may include, for example, a horizontal synchronization signal Hsync, a vertical synchronization signal Vsync, and a main clock MCLK.

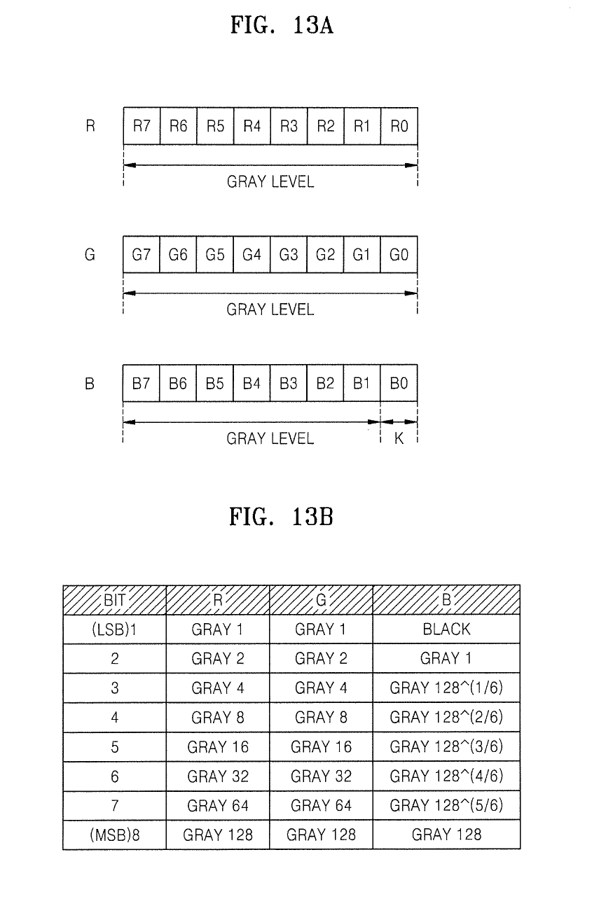

The signal generation unit 300 may receive from the input unit 600, transmittance information that indicates how much external light is transmitted or blocked per pixel. The signal generation unit 300 may generate transparent data by adding the transmittance information to the image data DATA, store (record) the transparent data in the storage unit 500, and output the stored transparent data. Alternatively, the signal generation unit 300 may generate and directly output the transparent data by adding the transmittance information to the image data DATA. The transmittance information may be represented by one or more transmittance bits to which at least one bit is allocated. For example, one or more of 24 bits representing the RGB signals per pixel may be allocated to transmittance information (e.g., as transmittance bits), or bits in addition to 24 bits may be allocated thereto. A structure of the transparent data according to embodiments of the present invention will be described later with reference to FIGS. 13 to 15.

The signal generation unit 300 reads the transparent data from the storage unit 500 to form an image, transfers the image data DATA and the control signal to the driver IC 200, and transfers transmittance information to the transmittance control unit 400. The signal generation unit 300 may store the transparent data including the image data DATA and the transmittance information in the storage unit 500 or to a separate storage unit or storage device, when the image data DATA is backed up after reproduction.

In embodiments according to the present invention, a transmittance control signal per pixel may be inserted into a given 24 bit system of the three primary color RGB signals or into an extended 24 bit system. Accordingly, modes of the display apparatus may be switched per pixel and a partial black mode may be implemented.

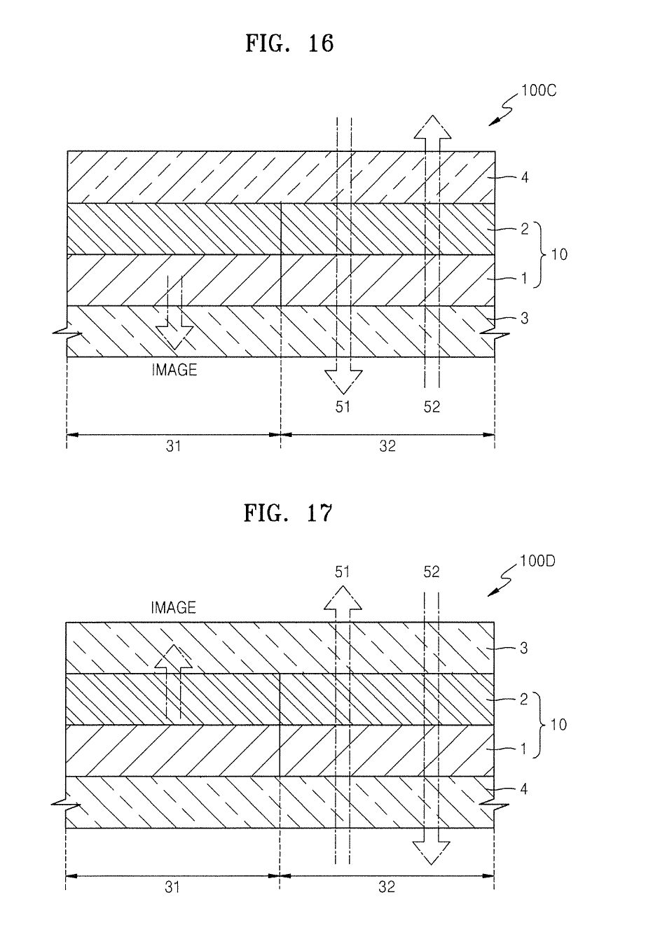

The transmittance control unit 400 may control modes of the display panel 100 per pixel by generating an appropriate transmittance control signal according to a construction of the transmissive region of each pixel based on the transmittance, and controlling a transmittance control device 4 included in the display panel 100 based on the transmittance control signal. The transmittance control device 4 may be an electrical and optical device for controlling transmittance of the transmissive region of a pixel. The transmittance control device 4 will be described later with reference to FIGS. 16 and 17.

The storage unit 500 may be a memory that stores the transparent data including transmittance information in addition to the image data DATA in a bitmap manner. The storage unit 500 may be volatile or non-volatile, and may use a storage medium capable of storing the image data DATA. The storage unit 500 may store data having a data format including the image data DATA and transmittance information, i.e. the transparent data, when the image data DATA displayed (reproduced) on a display is backed up.

The input unit 600 may input the control signal from the outside such as from a user. The input unit 600 receives a driving mode selection signal of the transmissive mode or the black mode in a pixel unit according to a user's input. Thus, information regarding an opaque region in which the black mode is implemented may be obtained and a partial black mode may be implemented. The input unit 600 may receive the transmittance information that indicates how much external light is transmitted or blocked in a pixel unit. The input unit 600 may be implemented using any device or devices with which the user can input information or control, such as a button, a keyboard, a touch pad, a touch screen, a remote controller, and the like.

FIGS. 13A through 15 are diagrams for explaining a structure of transparent data according to an embodiment of the present invention.

A TV or a video system may display an image, for example, by converting RGB signals into brightness signals Y and color signals C. In this regard, vision is more sensitive to brightness signals Y than color signals C. The G signal (e.g., G word) has the greatest contribution to brightness signals Y.

Thus, according to one embodiment of the present invention, transparent data includes transmittance information using at least one bit of the R signal (e.g., R word) and/or the B signal (e.g., B word), or using at least one bit added to the RGB signals.

Referring to FIG. 13A, the transparent data is represented (e.g., expressed) by 8 bits for each of the RGB signals, and transmittance information is represented by a least significant bit (LSB) of the B signal. In this case, image data and the transmittance information may be represented (e.g., expressed) using the whole 24 bits. Accordingly, the R signal and the G signal respectively represent (e.g., express) color information in a gray level using 8 bits, and the B signal represents (e.g., expresses) color information in the gray level using 7 bits. The transmittance of 0% (black) or transmittance of 100% (transparent) may be represented by the LSB (e.g., BIT 1) of the B signal. Referring to FIG. 13B, the transmittance of 0% (black) may be represented by the LSB of the B signal. If the transmittance information is represented using 2 LSBs, three or four transmittance types or levels may be expressed.

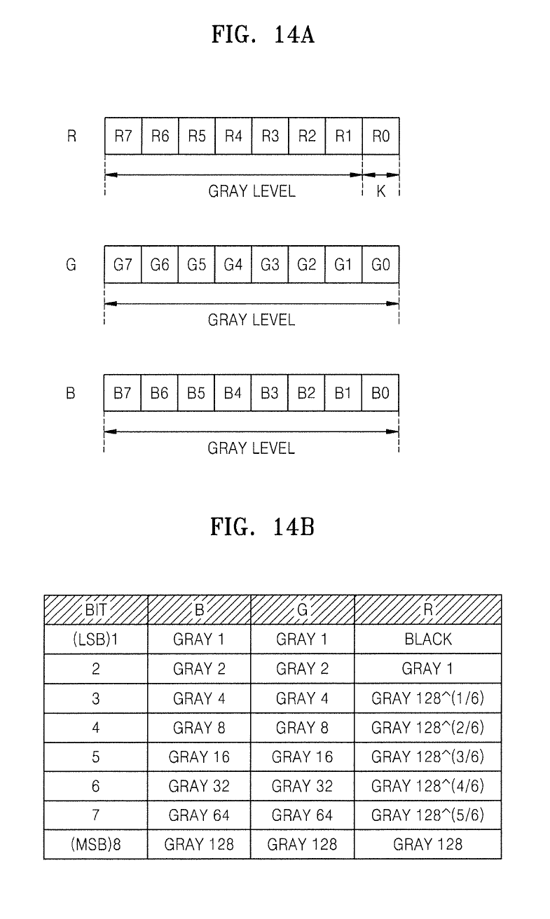

Referring to FIG. 14A, transparent data is represented by 8 bits for each of the RGB signals, and transmittance information is represented by an LSB of the R signal (e.g., R word). In this case, image data and the transmittance information may be represented using the whole 24 bits. Accordingly, the B signal (e.g., B word) and the G signal (e.g., G word) respectively represent color information in a gray level using 8 bits, and the R signal represents color information in the gray level using 7 bits. The transmittance of 0% (black) or transmittance of 100% (transparent) may be expressed by the LSB (e.g., BIT 1) of the R signal. Referring to FIG. 14B, the transmittance of 0% (black) may be expressed by the LSB of the R signal. If the transmittance is represented using 2 LSBs, three or four transmittance types or levels may be expressed.

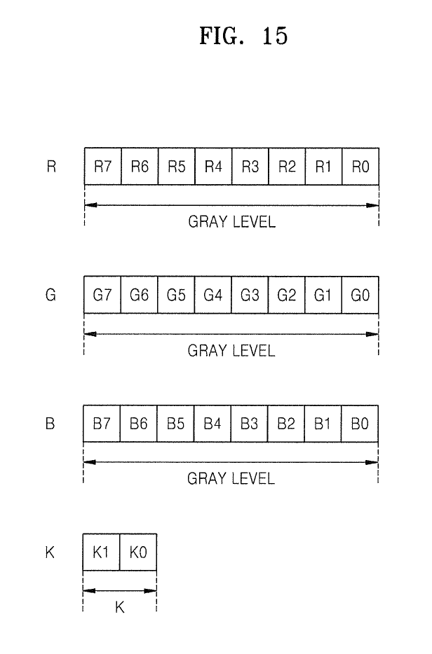

Referring to FIG. 15, transparent data is represented by 8 bits for each of the RGB signals, and transmittance information is represented by adding at least 1 bit. In this case, image data and the transmittance information may be expressed using the whole 25 bits. Accordingly, the RGB signals represent color information in a gray level using 8 bits respectively and 24 bits wholly, and the transmittance is represented by adding one or more bits. The number of transmittance types or levels represented may be set or defined according to a number of additional bits.

FIGS. 16 and 17 are schematic cross-sectional views of display panels 100C and 100D capable of controlling optical transmittance according to embodiments of the present invention.

Referring to FIG. 16, the display panel 100C, unlike the display panel 100A of FIG. 1, further includes an optical filter 3 and the transmittance control device 4 on the transparent display device 10 that transmits external light therethrough. The display device 10 may be a bottom emission type organic emission display panel. The elements of the display panel 100C are substantially the same as those of the display panel 100A of FIG. 1 in terms of their functions and thus will not be described again in detail here.

The optical filter 3 is disposed at an external side of the first substrate 1, via which light is emitted from the transparent display device 10. The optical filter 3 allows circularly polarized light, which circulates in a certain direction, to pass therethrough. Thus, the optical filter 3 is a combination of a linear polarizing filter and a retarder that phase-delays incident light by +¼ wavelength (+λ/4) or a circular polarizing filter.

The transmittance control device 4 is disposed at another external side of the second substrate 2, via which light is not emitted from the transparent display device 10.

As an example, the transmittance control device 4 may be an optical reflectance conversion device that converts reflectance of external light according to a mode. The optical reflectance conversion device may use a liquid crystal device (LCD) in which arrangement of liquid crystal varies according to an electric field applied or may be an electrochromic device in which the state of an electrochromic material changes when power is supplied thereto.

As another example, the transmittance control device 4 may be a retarder and a linear polarizing filter that delays a phase of incident light according to a mode. The retarder may use an LCD in which arrangement of liquid crystal varies according to an electric field applied or may be an electrochromic device in which the state of an electrochromic material changes when power is supplied thereto.

The transmittance control device 4 controls transmittance of a transmissive region of each pixel according to the control signal of the transmittance control unit 400.

Referring to FIG. 17, the display panel 100D, unlike the display panel 100C of FIG. 16, may be a top emission type organic emission display panel. Thus, the optical filter 3 is disposed at an external side of the second substrate 2, via which light is emitted from the transparent display device 10. The transmittance control device 4 is disposed at an external side of the first substrate 1, via which light is not emitted from the transparent display device 10. The other elements of the display panel 100D are substantially the same as those of the display panel 100C of FIG. 16 in terms of their functions and thus will not be described again in detail here.

The transmittance control device 4 controls transmittance of a transmissive region of each pixel according to the control signal of the transmittance control unit 400.

According to the above embodiments of the present invention, transmittance of a transparent display device may be controlled in a pixel unit by using an image signal and a transmittance signal (e.g., transmittance information or transmittance bit).

While this invention has been particularly shown and described with reference to exemplary embodiments thereof, it will be understood by those of ordinary skill in the art that various changes in form and details may be made therein without departing from the spirit and scope of the invention as defined by the appended claims and their equivalents.

What is claimed is:

1. A display apparatus configured to control optical transmittance thereof, the display apparatus comprising:
a display panel comprising a pixel having a first region for emitting light via at least one surface thereof and a second region disposed adjacent to the first region and for transmitting external light therethrough;
a signal generator for generating a signal comprising image words representing image data corresponding to the light emitted from the first region, one or more transmittance bits of the signal representing transmittance of the second region; and
a transmittance control device for controlling transmittance of the second region based on the one or more transmittance bits.

2. The display apparatus of claim 1, wherein the first region of the pixel comprises a light emission unit for each of a red sub pixel, a green sub pixel, and a blue sub pixel of the pixel, and the second region is independently disposed for each of the red sub pixel, the green sub pixel, and the blue sub pixel, or is coupled thereto.

3. The display apparatus of claim 1, wherein the image data comprises a red signal, a green signal, and a blue signal,
wherein the image words comprise a red word representing the red signal, a green word representing the green signal, and a blue word representing the blue signal.

4. The display apparatus of claim 3, wherein at least one bit of the red word is allocated to the one or more transmittance bits.

5. The display apparatus of claim 4, wherein the one or more transmittance bits comprise a least significant bit (LSB) of the red word.

6. The display apparatus of claim 3, wherein at least one bit of the blue word is allocated to the one or more transmittance bits.

7. The display apparatus of claim 6, wherein the one or more transmittance bits comprise an LSB of the blue word.

8. The display apparatus of claim 3, wherein at least one bit is added to the image words as the one or more transmittance bits.

9. The display apparatus of claim 1, wherein the transmittance control device comprises: an optical reflectance conversion device disposed at another side opposite to a side of the display panel via which light is emitted from the display panel, and is configured to change reflectance of the external light according to the one or more transmittance bits.

10. The display apparatus of claim 1, wherein the transmittance control device comprises: a retarder disposed at another side opposite to the side of the display panel via which light is emitted from the display panel, is configured to delay a phase of the external light according to the one or more transmittance bits, and to transmit the external light.

11. The display apparatus of claim 1, further comprising: a storage unit for storing the image words as image information, wherein the storage unit is configured to store the one or more transmittance bits.

12. A display apparatus configured to control optical transmittance thereof, the display apparatus comprising:
a display panel for selectively operating in a first mode in a transparent state in which external light transmits through the display panel displaying an image and in a second mode in an opaque state in which the external light is blocked from transmitting through at least a part of the display panel;
a signal generator for generating a signal comprising image words representing image data, one or more transmittance bits of the signal representing transmittance information used to control block or transmission of the external light; and
a transmittance control device for controlling transmittance of the external light based on the one or more transmittance bits.

13. The display apparatus of claim 12, wherein the display panel comprises pixels each comprising a first region comprising a light emission unit for each of a red sub pixel, a green sub pixel, and a blue sub pixel, and configured to emit light, and a second region adjacent to the first region, configured to transmit external light therethrough, and independently disposed for each of the red sub pixel, the green sub pixel, and the blue sub pixel or coupled thereto.

14. The display apparatus of claim 12, wherein the image words comprise a red word representing the red signal, a green word representing the green signal, and a blue word representing the blue signal.

15. The display apparatus of claim 14, wherein at least one bit of the red word is allocated to the one or more transmittance bits.

16. The display apparatus of claim 15, wherein the one or more transmittance bits comprise an LSB of the red word.

17. The display apparatus of claim 14, wherein at least one bit of the blue word is allocated to the one or more transmittance bits.

18. The display apparatus of claim 17, wherein the one or more transmittance bits comprise an LSB of the blue word.

19. The display apparatus of claim 14, wherein at least one bit is added to the image words as the one or more transmittance bits.

20. The display apparatus of claim 12, wherein the transmittance control device comprises: an optical reflectance conversion device disposed at another side opposite to a side of the display panel via which light is emitted from the display panel, and is configured to change reflectance of the external light according to the one or more transmittance bits.

21. The display apparatus of claim 12, wherein the transmittance control device comprises: a retarder disposed at another side opposite to the side of the display panel via which light is emitted from the display panel, is configured to delay a phase of the external light according to the one or more transmittance bits, and to transmit the external light.

22. The display apparatus of claim 12, further comprising: a storage unit for storing the image words as image information, wherein the storage unit is configured to store the one or more transmittance bits.
